(19) United States
(12) Patent Application Publication
(10) Pub. No.: US 2007/0270999 A1
(43) Pub. Date: Nov. 22, 2007

(54) Automated storage and distribution system

(76) Inventor: Munroe Chirnomas, Morris Township, NJ (US)

Correspondence Address: LAWRENCE C. EDELMAN, IP COUNSEL FASTCORP, 60 E. HANOVER AVE, B-2, MORRIS PLAINS, NJ, 07950, US

(21) Appl. No.: 11/374,310

(22) Filed: May 2, 2006

(51) Int. Cl. G06F 7/00

(52) U.S. Cl. 700/221; 700/242

(57) ABSTRACT

An automated facility for storing and then distributing articles. The facility includes a housing for receiving closed shipping containers, and further means for retrieving articles from inside the shipping containers and distributing the articles to an output of the housing. The further means includes a sensing means for determining the position of at least a portion of an outside surface of each one of a plurality of closed shipping containers that have entered into the housing, and an automated means to form an opening in each of the shipping containers. A computer controlled retrieving means is also provided in the housing for entering into selected ones of the shipping containers by passing through the formed opening so as to retrieve an article from inside one of the shipping containers, which article is then moved to an output of the housing.

### FIELD OF THE INVENTION

The present invention relates to a system for automatic handling of articles, and more particularly, in one aspect of the invention whereby the handling includes storage and distribution of the articles. Even more specifically, the invention relates to a system for automatically receiving, storing and dispensing containers and/or articles, and in a further embodiment, where at least some of the containers have a plurality of articles positioned therein.

### BRIEF DESCRIPTIONS OF THE DRAWINGS

The accompanying drawings, if any, which are incorporated herein and constitute part of this specification, illustrate embodiments and details of the invention, and, together with the general description given above and the detailed description given below, serve to explain the features of the invention.

### DETAILED DESCRIPTIONS OF THE INVENTION

In one aspect of the invention, an enclosed structure or housing includes a loading port for receiving containers to be transported into the housing, storage locations for storing at least some of the containers and/or articles, and a retrieval port for allowing containers and/or articles to be transported from inside the housing to a user of the system who is outside of the housing. A computerized control system is located in or near the housing and can control the apparatuses related to the system.

It is noted that it is not required that the loading port and retrieval port be structures that are separate from the housing, and in some embodiments of the invention, the loading and retrieval ports can utilize the same or different structures as the housing. It is also noted that the loading or retrieval port can be formed using a separate structure which is connected to the housing. The port may include conveyance apparatus which can include conveyor belts, elevator systems, pneumatic tube structures that are connected to or part of the housing. Additionally, in another embodiment, the port can be a secure door through which containers or packages are placed or retrieved manually.

In accordance with the invention, the housing includes apparatus for providing automatic handling of articles to be located therein.

One type of such automatic handling includes a conveyance apparatus for transporting a plurality of containers into the housing via the loading port and a conveyance apparatus for transporting the containers (or articles that were located inside the container), via the retrieval port, to a user of the housing who is located outside of the housing. The conveyance apparatuses noted above can be totally separate from one another, or can comprise a combined or even the same apparatus. It is noted that by the term container, applicant means any type of containing device, such as a box, carton, bag, tube, etc. The containers can have one article or item contained within them and or can have a plurality of items stored within them.

Additionally, the system can have a container identification (ID) system which can determine which container is being presented to the housing and which can then enable the control system to determine whether the container is authorized to be conveyed into the housing or into the storage area within the housing. This determination by the control system can be based on many factors, which may include, whether the control system was anticipating the specific type of container or the specific unique package at that time. Additionally, the determination to allow the container into the housing can be based on whether the control system determines that there is sufficient space in the housing to store the container. The ID system can include a bar code scanner, an RFID device, a camera, an optical sensor, mechanical sensors or other sensors

The housing may also include an apparatus for automatically creating an opening in a portion of a container which may include the removal of a portion of a container, the opening created in the container being of sufficient dimension and location in the container so that articles located in the container may be removed from the container. Alternatively, the container may never be opened by the opening apparatus, and transported to the second storage location in an intact and unopened state.

It is noted that various types of known systems can be used for manipulating the container, and/or the cutting instruments for creating the opening in the container, such as rotating and/or stationary blades, laser beam cutters, etc. Such cutting devices are known in the industry, see for example U.S. Pat. No. 6,863,486.

A conveyance apparatus is used for bringing the container to a storage location in the housing whereby the storage location can include a shelf or rack, and whereby the conveyance apparatus may include a traditional type of conveyor belt or chain driven transport system (powered by a device such as a motor, a hydraulic or pneumatic system, a screw feed, a rack and pinion, or a piston mechanism or some other mechanical device), and may or may not be used in conjunction with further article handling mechanisms, such as a gantry robot, a multi axis articulated arm robot, or some other mechanically based article handling system.

This conveyance to the storage location can be done before or after any opening is made in the container.

In the event the container is to be opened, once the opening in a container is provided, an article retrieving device located in the housing can access the opening for removing the articles from inside the container, thereby enabling the articles to be transported to a second location. Such transportation of the article to the second location can be done by the article retrieving device, or can be done in combination with a further conveyance apparatus.

In one embodiment the removal of an article from a container can be accomplished using a gripper. The gripper can include a vacuum based suction cup or mechanical claw type gripper or other material handling mechanism, all of which are commonly know in the art. In order to facilitate the proper retrieval of items from the container, a robotic device utilizing optical, vision, vacuum or other sensors can be used.

It is noted that in a preferred embodiment, a disposal apparatus is provided for securing to the material, if any, which may have been removed from the container to form the opening, so as to transport any such material to a disposal or recycling area. Such securing apparatus can include a mechanical or suction-type gripper, a robotic arm, or some other material handling device. A portion of the apparatus that removes a portion of the container and creates or forms the opening, can also form part of the apparatus used to remove and dispose of that material removed to form the opening.

It is also noted that the housing could have multiple storage locations therein so as to accommodate a plurality of containers of similar or different shape and/or size. Each container may have similar or different items or articles inside them. A container could have only one item contained inside, while another container could have a plurality of items or articles contained inside.

It is noted that the article retrieving device which removed the article from the container, could be all or part of the conveyance apparatus that puts the article in the second storage location. Alternatively, e the article can be moved with a separate conveying apparatus to the second location.

In accordance with one aspect of the invention, the second location can be or have co-located therewith, a further container, such as a non-returnable bag or box, that is delivered to an end user. Such further container is hereinafter called a delivery container. In one embodiment, the delivery container can move with the article retrieving device so as to be positioned to directly receive one or a plurality of articles from the article retrieving device, which articles were removed from one or a plurality of containers. Once the article is in the delivery container, the system can dispense that container with one or a plurality of items requested by the user, to be conveyed out of the retrieval port of the housing and to the end user (or a package delivery service). Alternatively, the delivery container can be held for an indeterminate period of time in order to receive additional items and/or to be held for a few hours, days, or more for later pick-up by an end user (or a package delivery service). Thus, the delivery container receives the items requested by the end user. In the event that the items requested are unopened containers, then it is possible that no delivery container would be used.

The delivery container may be of the type which is preformed before being located in the housing, or it may be of the type which is formed within the housing, such forming can be accomplished using any one of known carton or bag forming devices, and the carton or bag can be formed so as to have handles to assist the user or a delivery service for the transportation and/or movement of the container to the end user.

In another embodiment, there is no delivery container, and the stored articles are delivered directly and individually to the user waiting at the retrieval port, via the conveyance apparatus without the use of a bag or carton.

In a preferred embodiment, the system can seal the delivery container, using for example an adhesive tape. Additionally, automatic means can be provided so as to print or otherwise affix to the container addressee, user or shipping information so that the delivery container is ready to be received by a package delivery service for delivery to the end user.

It is noted that the housing can have various sections, each section having a different environmental condition, such as a different temperature or humidity, such conditions being attained by the use of air-conditioning or other refrigeration system located in, on, or near the housing, thereby enabling at least a portion of the inside of the housing to kept air conditioned, refrigerated, frozen, heated and or ambient.

In accordance with a further aspect of a preferred embodiment of the invention, a payment mechanism and or order entry interface is associated or otherwise included with the automated storage and distribution system. For example, when the system and structure comprises a retail store for the storage and sale of goods, there are several ways a user of the store can order items and or access the payment system, such as by:
i) using an internet oronline based access,
ii) using an order entry interface device which is located outside the housing, but in proximity thereto, such as a touch screen, bar code scanner and menu/list system, or other input device, to enable users to request one or more of the articles in the store, or
iii) using a user supplied device when the user is in close proximity to the store, such as a PDA or a cell phone.

Additionally, a variety of end user payment systems may be used in conjunction with the storage and distribution system for enabling the end user to pay for the articles delivered to him. The end user payment can be made by cash, debit, credit or other electronic method, and can be made at the site of the storage system or can be processed via a remote link which can include via the internet or cell phone.

The automated storage and distribution system can also be accessed using a security code or other method which can include a magnetic card, a biometric device, a PIN number code or other similar system. This will enable a delivery service to deliver or remove articles or packages from the enclosure in a secure manner.

The system can be used as a sales system thereby distributing goods in exchange for payment, or alternatively, it can be used as a secure distribution system which prevents access of stored items from being retrieved unless a person has authorization to do so, such as a delivery service which is retrieving a parcel from the enclosure for further transportation.

In an alternative use, the system can be used as both an automated warehouse for controlling the access of the goods inside for security purposes, and additionally can also allow items to be sold from the system as the need may arise.

Therefore, it is possible that the very same system can function at any given time as either a secure distribution warehouse and or a retail or wholesale outlet. So for example, a parcel delivery company can use the system as a distribution depot for the transfer of goods from one distribution site to another one or to a final customer where, payments are not necessary for accessing the goods or containers inside. In another scenario, the very same system can be selling items from the housing to other persons who are interested in purchasing goods from the system.

Additionally, the system can be utilized as a public warehousing or distribution system enabling people to have items stored in the housing and whereby they can retrieve the items or packages at a time of their own choosing.

The above noted devices can be accessed by the user from their car, by walking up to the housing or by sitting in an adjacent or attached structure or room which is attached to or in proximity to the housing.

For enhanced services from the store, a user can access a remote site via a remote video and/or audio link to a live person, if the end user at the store needed assistance.

In accordance with a further aspect of a further preferred embodiment of the invention, the automated storage and distribution system includes a container sensing system. The sensing system can be used to identify the orientation of the containers in the housing using sensing mechanisms, such as mechanical sensors, a vision or image or other optical device, as well as a bar code device or radio frequency ID tag device (RFID).

Such a sensing system may cooperate with the robotic or conveyor apparatus, in order to assist with re-orientation of the container in a manner so as to prepare it for storage, or for assisting with the forenoted manipulation so as to ensure the container is properly placed before forming the opening therein.

The forenoted article retrieval device can use an imaging system, and or additional sensors such as suction sensors, pressure sensors or proximity sensors to identify where and how to grab or otherwise secure to the articles to be removed from the container. It is also noted that the article retrieval device may, if desired, grab more than one articles when removing them from the container.

Information relating to metrics of the container dimensions, container contents, opening orientation and instruction set, internal layout of articles within the container or carton, color or shape of the articles or packages inside the container or carton, whether the items contained inside are of a delicate or rugged nature, can all be accessed by the system from a database which can be stored at the site of the housing or can be remotely updated to the system via a remote link, including using the internet, a wireless system or a wired communication connection. These metrics can be used by the control system to assist in the handling and or the manipulation of containers and the articles retrieved from them.

It is noted that in accordance with a further aspect of a preferred embodiment of the invention, a shipping container such as a cardboard box which is stored in the housing, once opened, may be used as a storage container for the articles, that is, the shipping container is moved to a storage location with all the articles still positioned inside the container, and then the article retrieval device selectively removes articles from one or more of the stored containers, in order to fill a request for articles from an end user (i.e., customer). In this way, there is no need to have a person manually load the items discretely into a storage area within the housing, since the container in which the items were transported to the distribution system housing, also acts as the storage device from which the individual items may be automatically retrieved by the retrieval device.

A particular advantage of the present arrangement is that it provides an automatic, i.e., non-human contact, process which allows an end user to obtain individual ones of articles that are shipped in bulk in a sealed container from a manufacturer. That is, the shipping containers received into the housing could have been “sealed” at the factory or warehouse of the manufacturer of the articles, and an end user can obtain one or more of the articles from inside one or more of the various containers stored inside the housing, in a manner that does not involve human contact with the articles.

As noted above, in another embodiment, the system can distribute and or convey unopened containers as well as items from opened containers to the retrieval port. This may be desirable since some containers may only have one item inside, or a given user may wish to retrieve or purchase a full carton of a specific item.

In an even further aspect of a preferred embodiment of the invention, once all the articles have been removed from a shipping container, the disposal apparatus attends to disposal of the container. In one embodiment, the apparatus may convey the empty container to a disposal location with one or more compacting devices that may be located in or attached to the housing.

In an even further aspect of a preferred embodiment of the invention, metrics regarding the container are, in advance, and either remotely or directly, input to a computer controller of the automatic storage and distribution system, which metrics provide information to the vision and/or opening devices. Once the container and its contents have been identified, specific to attributes of various ones of the containers and the articles positioned therein can be used to determine and or control further handling and transportation of the container and its contents into and around the inside of the system.

Additional feature of a preferred embodiment can include remote video monitoring of the system which can monitor any part of the process inside or outside the housing so that if there is, for example, a malfunction or a personal security issue, a computer or a person at a remote location can assess the situation and can even remotely take control of the system in order to rectify a given problem.

Additionally, a person loading containers to the port or the housing can be required to input an authorization code through one of various electronic means, including a magnetic card, a PIN number, a fingerprint reader or other method which would enable that person to activate a secure loading port thereby enabling him to load a container into the housing. Both the loading port and the retrieval port can be designed to be secure, thereby not allowing any person access into the housing area or the storage area. So, while a person may be authorized to deliver packages or cartons to the housing, that same delivery person has no access to the inside of the housing and he cannot access any containers or packages which are located inside the housing. In this way, the person delivering the containers does not have to be a person who the owner of the distribution system has had any prior dealings with and there is no need to have any relationship of trust or otherwise in order for the delivery person to facilitate the loading of containers or packages into the housing of the distribution system.

A particular advantage of the above system and its various embodiments, as compared with prior art storage and distribution systems, or retail stores, is that a significant cost of such prior art systems is due to the labor involved in moving cartons (with or without further articles positioned therein) from the manufacturer to an intermediate storage/distribution facility and then to the location where the user will pick-up the articles (i.e., such as onto the shelf of the retail store). Such shipping, storage and handling costs experienced by the article manufacturer and the store owner/operator are ultimately passed on to the end customer, as reflected in a higher final sale price of the article. On the other hand, the system of the invention allows the storage and distribution system (i.e., a retail store or a warehouse distribution system built according to the present invention) to leverage existing article transportation infrastructure and services, such as the United Parcel Service (UPS) and Federal Express (Fex Ex) or other general trucking and transportation companies, to deliver the containers to the housing of the inventive system. These existing transportation service companys typically provide for package and container transportation to any place on the globe at a highly efficient and competitive price. Thus, by using such service company's for container transportation and loading of a structure in accordance with the present invention, this feature results in a significant savings over an article manufacturer having to distribute his products on his own, thereby requiring a fleet of trucks, drivers and a plurality of centrally located distribution centers as well as all of the trustworthy personnel required to stock the shelves and or pick the products.

The system of the invention also includes automated systems inside the housing which attend to the initial sorting, final storing and then ultimate distribution of the articles to the end user, all without additional costs for employee labor or providing the physical and financial infrastructures needed for employees. Thus, many of the financial overhead and real-estate costs involved in the operation of a retail store or a distribution warehouse are avoided.

A further advantage relating to the fact that the above handling of the cartons and articles inside the housing is accomplished in a mechanized and automated way, without human intervention, is that:
the loading of the housing with the cartons can be accomplished by a person, such as the truck driver/carton delivery person,
employee and third-party delivery person related issues, such as article and monetary theft, as well as article damage due to mishandling, is avoided.
These advantages result in real cost savings for the automated store owner/operator, and allow for greater profit margins without increasing the cost of the articles being dispensed as compared with traditional stores.

While the present invention has been disclosed with reference to certain embodiments, numerous modifications, alterations and changes to the described embodiments are possible without departing from the sphere and scope of the present invention, as defined above. Accordingly, it is intended that the present invention not be limited to the described embodiments, but that it has the full scope defined by the above language, as well as equivalents thereof.

In accordance with the above description, the present invention includes, among other features:
1. an enclosure
2. a port which enables transfer of packages into the enclosure, this port can include a means for controllably blocking access into the housing,
3. a port which enables transfer of packages out of the enclosure, this port can also include a means for controllably blocking access into the housing, and,
4. means for removing of a portion of packages in the enclosure so as to make an opening, so articles stored therein can be automatically, and without human contact or intervention, removed from the package.

In accordance with further aspects of the invention:
at least one container which has been transferred into the housing through the port includes a plurality of “articles” therein.
A container opening device including a cutting device, for cutting the container to make an opening in the container.
Further including an article retrieving device located in the enclosure for removing articles from a container using the opening, and transferring the articles to a further location.
providing to the user goods that are retrieved from a location in the enclosure upon the users request.
where the further articles were received into the enclosure in one or more packages which were sealed by the supplier of the articles, and the articles were delivered to the end user at the retrieval of the housing by fully automatic means in the housing, so that the articles are removed from the sealed packages and then delivered to the user all without human contact.

Furthermore:
1. the further location may be a predetermined storage location in the enclosure, or
2. the further location may be the retrieval port.
3. Where the further location may be a “dispensing container” which is provided to the user via the retrieval port
4. Transfer means are located inside the housing to transfer at least one of the packages from inside the housing to outside the housing through a port,
5. Where an article retrieval device provides the articles to the transfer means from a storage location inside the housing.
6. Where that port can restrict access to the packages which remain inside the enclosure.
8. where the loading port and the retrieval port are the same port, or
9. where the loading port and the retrieval port are different ports.

In accordance with another embodiment, the present invention includes:
1. an enclosure
2. a port which enables transfer of packages into the enclosure
3. a port which enables transfer of packages out of the enclosure, and
4. Further including a conveyance system for transferring the packages from the port into the enclosure, the conveyance system including:
   a. Means for identification of the package and or articles inside the package
   b. Apparatus for analysis of the orientation of the package
   c. Apparatus for manipulation of the package based on the orientation analysis
   d. Apparatus for determination if the package is acceptable to enter the enclosure
      i. where the Determination is based on bar code/input scan of the package,
      ii. where the Determination is based on what the housing was expecting via advance knowledge, such as via a wireless connection

In another embodiment, the invention comprises:
1. enclosure for storing packages therein, having a loading and retrieval port
2. a conveyor for transporting packages into the enclosure,
3. A system for removing a portion of a package after being transported into the enclosure, the portion being removed creating an opening in the package from which individual articles may be removed, and
4. An article retrieving device located in the enclosure for removing articles from the package via the opening and transferring the articles to a further location.
   a. Where the further location is a storage location in the enclosure
   b. Where the further location is the retrieval port.

Business methods in accordance with the invention include using the above-noted enclosure and apparatus to make an automated package/article storage and retrieval system which can use the shipping facilities of “common carriers” to “load” the enclosure with the packages and articles to dispensed to the end users.

This method allows multiple manufactures, each making a different article, to ship their items in bulk to a given distribution storage facility which can then “load itself” without human intervention, thereby resulting in significant cost savings in shipping, as well as reduced personnel costs at the enclosure.

1. An automated store for storing and selling articles, the automated store having a housing for
receiving a plurality of different types of closed shipping containers into the housing for storage, each of the closed shipping containers having a plurality of articles contained therein, and for distributing said articles to an output of the housing articles which were retrieved from inside stored shipping containers, CHARACTERISED BY:
a sensing means for determining the position of at least a portion of an outside surface of each one of the plurality of closed shipping containers that have been received into the housing; and
a computer controlled forming means which uses the determined position specific to each of the closed shipping containers to form an opening in each of the plurality of the shipping containers, which formed opening is positioned and dimensioned in a manner so as to allow automated retrieval of articles from inside of the opened shipping containers.

2. A fully secured automated store for storing and selling articles, the automated store having a housing which is sealed and operated by computer control so that no people are required to be inside of the housing for receiving closed shipping containers into the housing for storage, and for distributing articles to an output of the housing, which articles were retrieved from inside of stored ones of the shipping containers, comprising:
a computer controlled secure entry means for receiving a plurality of closed shipping containers at an entry point thereof, said entry means controlling entry into the housing of so that only closed shipping containers which are authorized are passed into the housing, where at least some of the plurality of closed shipping containers which are entered into the housing have outer dimensions which are different from the outer dimensions of other ones of the plurality of closed shipping containers which are entered into the housing;
an automated forming means for forming an opening in a plurality of the shipping containers which entered into the housing;
a storing means for storing the plurality of opened shipping containers inside a storage area of the housing;
a computer controlled retrieving means for entering into selected ones of the opened shipping containers located in the storage area, by passing through the formed opening so as to retrieve an article from inside one of the stored opened shipping containers; and
moving means for moving the retrieved articles to an output of the housing.

3. A method of operating an automated store for storing and selling articles, the automated store having a housing for receiving closed shipping containers into the housing for storage, and for distributing articles to an output of the housing, which articles were retrieved from shipping containers stored inside the housing, comprising the following steps:
controlling entry into the housing of a plurality of various different types of closed shipping containers, with at least some of the plurality of closed shipping containers having outer dimensions which are different from the outer dimensions of other ones of the plurality of closed shipping containers;
developing information which identifies at least one of the position and type of a plurality of the closed shipping containers;
using the developed position and type information to form an opening in the container,
which opening is positioned and dimensioned for allowing automated retrieval of articles from inside of the container;
storing the container inside the housing; and
retrieving selected articles from said stored containers, and distributing them to an output of the housing.
